(19) United States
(12) Patent Application Publication
(10) Pub. No.: US 2009/0229345 A1
(43) Pub. Date: Sep. 17, 2009

(54) PHOTOACOUSTIC SPECTROSCOPY DETECTOR AND SYSTEM

(75) Inventor: Hans Willem Van Kesteren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,042

(22) PCT Filed: Feb. 22, 2006
(86) PCT No.: PCT/IB2006/050572

§ 371 Date: Aug. 24, 2007

(30) Foreign Application Priority Data
Mar. 4, 2005 (EP) 05300164.0

(51) Int. Cl. G01N 21/17

(52) U.S. Cl. 73/24.02

(57) ABSTRACT

An acoustic detector (10), for detecting acoustic signals generated in a photoacoustic spectroscopy system (1) through absorption of light by a fluid, comprising a sensing unit (11), said sensing unit (11) exhibiting structural resonance at or near a frequency of the acoustic signals. The sensing unit (11) forms at least part of a cavity resonator, which is arranged to enable a formation of standing pressure waves inside said cavity resonator at a cavity resonance frequency substantially coinciding with a structural resonance frequency of the sensing unit (11). The present invention is based on the realisation that an enhanced sensitivity of an acoustic detector in a PAS-system can be obtained by forming the acoustic detector as a cavity resonator with dimensions chosen so that the cavity resonance of the detector cooperates with the structural resonance of the sensing unit comprised in the detector, thereby achieving optimal amplification of the acoustic signals generated in the PAS-system.

The present invention relates to an acoustic detector, for detecting acoustic signals generated in a photoacoustic spectroscopy system through absorption of light by a fluid, comprising a sensing unit, said sensing unit exhibiting structural resonance at or near a frequency of the acoustic signals.

The invention further relates to a photoacoustic spectroscopy system, comprising a light source, an acoustic detector according to the invention and an output device configured to display information from the detector to a user.

In Photo-Acoustic Spectroscopy (PAS), a light source, such as a laser, emitting light at an absorption frequency of specific molecules contained in a sample is amplitude or frequency modulated. This modulation results in periodic pressure variations in a test cell containing the sample, due to temperature variations resulting from absorption of the light in the sample. These periodic pressure variations can be picked up by an acoustic detector, such as a microphone, and information can thus be obtained about the amount of absorption, which is proportional to the concentration of the absorbing molecules in the sample.

PAS is a well-known technique for trace-gas detection and has recently been studied for application in breath testing.

Representative examples of applications of breath testing are monitoring of asthma, breath alcohol, detection of stomach disorders and acute organ rejection. Furthermore, early clinical trials indicate possible applications in the pre-screening of breast and lung cancer.

Nitric oxide (NO) is one of the most important diagnostic gases in the human breath. For example, elevated concentrations of NO can be found in asthmatic patients. Typical concentrations of exhaled NO levels found in the human breath are in the range of parts per billion (ppb) and can only be measured using expensive and bulky equipment based on chemiluminescence or advanced optical absorption spectroscopy.

There is thus a need for a compact and low-cost device for measuring these very low concentrations of trace gases, such as NO, in the human breath. Besides the human breath, there is also a rising interest in trace gas detection for monitoring the purity of industrial process gasses and the detection of pollution gases in the atmosphere and from car exhausts.

A drawback of conventional PAS-systems is that powerful, table-size lasers and bulky gas-cells are required.

According to one recent development aimed at alleviating this drawback, it has been shown that infrared quantum cascade lasers, with dimensions comparable to conventional semiconductor lasers are feasible for use in PAS-systems.

In WO 03104767, another recent development towards more compact PAS-systems is disclosed. Here, a quartz tuning-fork, such as might be used in a wrist watch, is used as a detector in a PAS-system. In the above-mentioned patent application, the quartz tuning-fork is further combined with an acoustic resonator or tube, preferably manufactured in stainless steel or glass. This acoustic resonator is arranged so that a standing wave is formed inside the resonator and the tuning-fork is inserted in the resonator at the position of an antinode. The pressure variations between the prongs of the tuning-fork are thus amplified.

A drawback of this arrangement is that the tuning fork has to be exactly positioned in order to benefit from the amplified acoustic signal. This may lead to time consuming and delicate adjustment to be performed before the measuring system can be used.

In view of the above-mentioned and other drawbacks of the prior art, a general object of the present invention is to enable improved measurement of the concentrations of substances, for example trace gases, in fluids, such as the human breath.

An object of the present invention is to provide an improved detector in a PAS-system.

An further object of the present invention is to provide a more sensitive PAS-system.

These and other objects are achieved according to the present invention by an acoustic detector, for detecting acoustic signals generated in a photoacoustic spectroscopy system through absorption of light by a fluid, comprising a sensing unit, said sensing unit exhibiting structural resonance at or near a frequency of the acoustic signals, wherein the sensing unit forms at least part of a cavity resonator, which is arranged to enable a formation of standing pressure waves inside said cavity resonator at a cavity resonance frequency substantially coinciding with a structural resonance frequency of the sensing unit.

“Resonance” is generally defined as a phenomenon of an oscillating system whereby a weak, periodic external perturbation (driving force) within a narrow frequency range can result in a strong increase in amplitude of the oscillating system. The amplitude increase is dependent on the frequency of the driving force and the maximum amplitude is reached when the frequency of the external perturbation approaches an eigenfrequency of the system.

In the PAS-system of the present invention, the acoustic detector is the oscillating system and the pressure variations in the fluid constitute the external perturbation. Two resonances are involved in the acoustic detector according to the invention, a structural resonance and a cavity resonance, which, when combined effectively, provide an extra boost in the sensitivity of the detector.

“Cavity resonance” is a geometrical phenomenon, where the resonance frequency is determined by the dimensions of a cavity and the speed of sound in a fluid inside the cavity. When a sound wave (pressure wave) enters a cavity resonator with suitable dimensions, a standing wave is formed in the cavity resonator and the sound wave is amplified at antinodes and cancelled at nodes.

“Structural resonance” refers to the internal resonance of a solid structure and is determined by its material properties and geometrical shape.

The present invention is based on the realisation that an enhanced sensitivity of an acoustic detector in a PAS-system can be obtained by forming the acoustic detector as a cavity resonator with dimensions chosen so that the cavity resonance of the detector co-operates with the structural resonance of the sensing unit comprised in the detector, thereby achieving optimal amplification of the acoustic signals generated in the PAS-system.

Compared to prior art, an acoustic detector according to the invention has several advantages.

A sensing area of the detector and an interaction of the detector with an acoustic volume are significantly improved compared to the prior art. Practically all the energy accumulated in antinodes of a standing pressure wave formed inside the detector is used to excite vibrations in the detector at one of the structural resonance frequencies of the sensing unit and the sensitivity is thus greatly improved.

Furthermore, since the functions of a detector, having a structural resonance frequency, and a cavity resonator can be fulfilled by one unit, no geometric adjustments of tuning-fork sensor and geometric acoustic amplification tubes are needed and time is thus saved.

Preferably, the sensing unit can comprise a piezo-electric material, such as quartz.

A piezo-electric material is a material that is deformed when it is exposed to an electric field. Conversely, a voltage between two ends of the piezo-electric material will be generated when the material is deformed.

By forming the sensing unit, comprised in the acoustic detector, so that it comprises a piezo-electric material, such as quartz, barium titanate, lead zirconate titanate (PZT) or polyvinylidene fluoride (PVDF), the output from the detector can be obtained in the form of electrical signals directly rather than indirectly by, for example modulation of an optical path (interferometric methods).

In order to provide more degrees of freedom in the design and manufacturing of the detector, as well as to enable a lower production cost, the sensing unit may be formed by two or more materials. One of the materials may be quartz and the other material may be a plastic material or a metal. Said other material may be chosen based on its mechanical properties, ease of machining or molding and cost. In another embodiment the detector might be configured as a Micro Electro Mechanical System (MEMS) resonator where periodic position variations are transferred into capacitance variations that can be detected electronically.

According to one embodiment of the detector according to the invention, the sensing unit can form a cavity.

By providing the sensing unit in the form of a cavity, the sensing unit may function as a stand-alone acoustic detector, in which a cavity resonance frequency of the sensing unit substantially coincides with a structural resonance frequency of the sensing unit.

In another embodiment of the detector according to the invention, the sensing unit can comprise a tube, having inner dimensions adapted to enable cavity resonance in a cavity formed by the detector comprising the tube at a frequency substantially coinciding with a structural resonance frequency of said tube.

The tube can, for example, be cylindrical and have a length, a radius and two ends, which may be open or closed. A tube, open at both ends can easily be placed inside a gas cell having transparent walls and containing the sample to be analysed. The cavity resonance frequency of a tube is easily calculated and the manufacturing of a cylindrical tube in particular is straight-forward.

According to a further embodiment of the detector according to the present invention, the above-mentioned tube comprises at least one slit in an envelope of the tube, said slit substantially extending in an axial direction.

If the sensing tube is modified with one or several slits in the envelope of the tube, the structural resonance frequency of the tube can be fine-tuned while keeping the cavity resonance frequency (the frequency at which standing waves in the tube occurs) essentially unchanged.

Preferably, the at least one slit in said sensing tube is arranged to extend from a first end of the tube and more than half-way towards a second end of the tube.

By modifying the tube with one or several slits substantially extending along the length of the tube, the quality factor of the sensing unit, comprising the tube, can be increased and the sensitivity and SNR (signal-to-noise ratio) thus improved.

According to another embodiment of the detector according to the invention, said sensing tube is divided in the axial direction into at least two segments which are held together by connecting means comprising bridges formed between the segments.

By providing the sensing unit in the form of a segmented tube, the expansions and contractions of the piezoelectric material are substantially located to the connecting means. Thereby, a larger signal can be obtained, since the force exerted by the pressure wave antinodes will result in a larger expansion in the connection means than in the un-segmented tube.

With at least one bridge connecting a pair of tube segments, a well-defined area for localised expansion and contraction of the piezoelectric material is formed. Electrodes can be arranged on the inside (facing the interior of the segmented tube) and outside of the bridge, respectively. Thereby, a voltage, corresponding to the thickness (in a radial direction) of the bridge can be obtained. This thickness is inversely proportional to the force exerted by the pressure waves on the tube segments. In this manner, a more sensitive measurement is enabled.

According to a further embodiment of the acoustic detector according to the present invention, the sensing unit can be a tuning fork with two prongs attached to a base.

By forming the sensing unit as a tuning fork with two prongs, which are preferably made of a piezoelectric material, attached to a base, the high quality factor and narrow structural resonance of a tuning fork can be taken advantage of.

Preferably, the above-mentioned detector can further comprise a cavity-forming member, said member being arranged to enable the formation of a cavity, bounded by the cavity-forming member and the prongs and base of said tuning fork.

By positioning a cavity-forming member, such as a plate, in such a way that a cavity, walled by this plate and the base and the two prongs of the tuning fork, a cavity resonator can be formed. By properly dimensioning this cavity resonator, the cavity resonance can be made to co-operate with the structural resonance of the tuning fork. The cavity-forming member is preferably positioned at a small distance from the tuning fork prongs and not contacting them.

According to another embodiment, the prongs of said tuning fork can be configured to form an essentially tube-shaped cavity between said prongs.

By shaping the prongs of the tuning fork in such a way that the prongs together form an essentially tube-shaped cavity, the cavity resonance inside the cavity can be made to co-operate with the structural resonance of the tuning fork, thereby achieving a very efficient transformation of the acoustic energy into electrical signals from the tuning fork, which may have piezoelectric prongs and/or a piezoelectric base.

According to a further embodiment of the detector according to the invention, the sensing unit is formed as an open-ended box, having dimensions which are adapted to enable cavity resonance of a cavity formed by the detector at a frequency substantially coinciding with a structural resonance frequency of said open-ended box.

Advantageously, two sides of said open-ended box are made of a piezoelectric material, said sides facing each other and being held together by two passive plates facing each other.

With this arrangement, the expansions and contractions of the two piezoelectric sides can readily be monitored. These expansions and contractions will be particularly strong when the cavity resonance of the detector comprising the open-ended box coincides with the structural resonance of the piezoelectric walls of the box. By forming the sensing unit as an open-ended box according to the above, the design of a cavity resonator with a suitable structural resonance frequency is facilitated.

Preferably, said passive plates of said open-ended box can be configured to form an essentially tube-shaped cavity between said them.

According to another embodiment, the detector according to the invention can further comprise signal enhancing means, said signal enhancing means being arranged to co-operate with said sensing unit to form a cavity resonator having dimensions which are adapted to enable cavity resonance of the detector at a frequency substantially coinciding with a structural resonance frequency of said sensing unit.

In some cases it may be advantageous to use a sensing unit with dimensions which might not be suitable for the formation of a cavity resonator at the desired frequency range. The cavity resonance of the detector can then still be made to substantially coincide with a structural resonance frequency of the sensing unit through the use of said signal enhancing means. The signal enhancing means are preferably arranged as close to the sensing unit as possible to, together with the sensing unit, form a cavity resonator.

These and other aspects of the present invention will now be described in more detail, with reference to the appended drawings showing currently preferred embodiments of the invention.

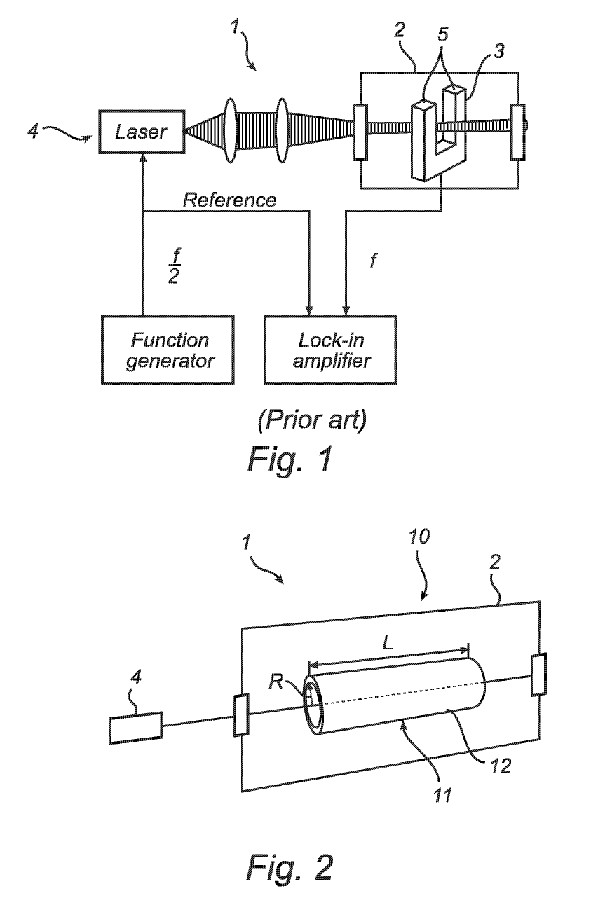

FIG. 1 is a schematic view of a prior art PAS-system, where a tuning fork is used as an acoustic detector.

FIG. 2 is a schematic view of a PAS-system comprising an acoustic detector according to a first embodiment of the present invention.

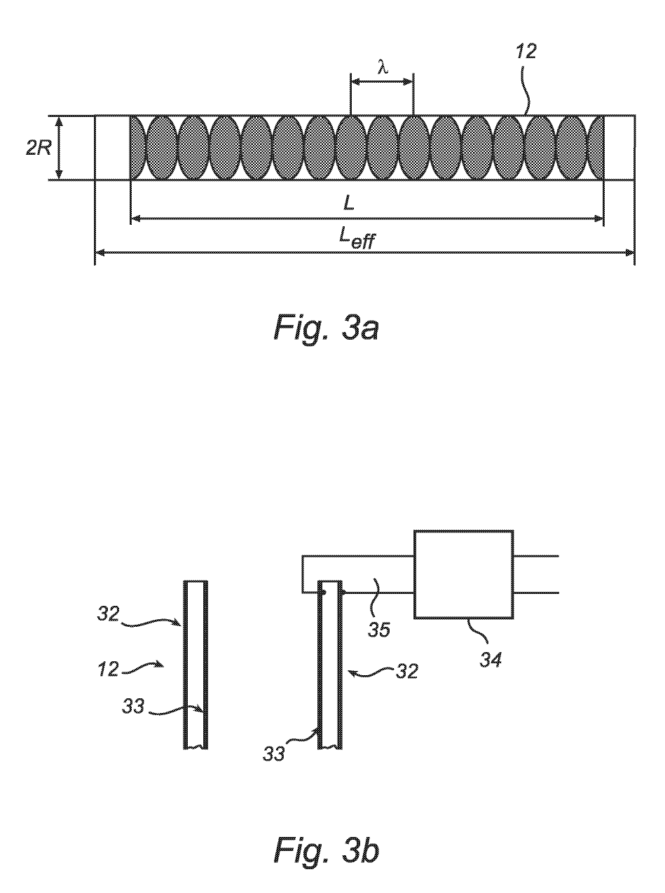

FIG. 3a is a schematic view of an example of an acoustic detector according to the first embodiment of the present invention.

FIG. 3b is a schematic view of an example of a poling configuration of the sensing unit in FIG. 3a.

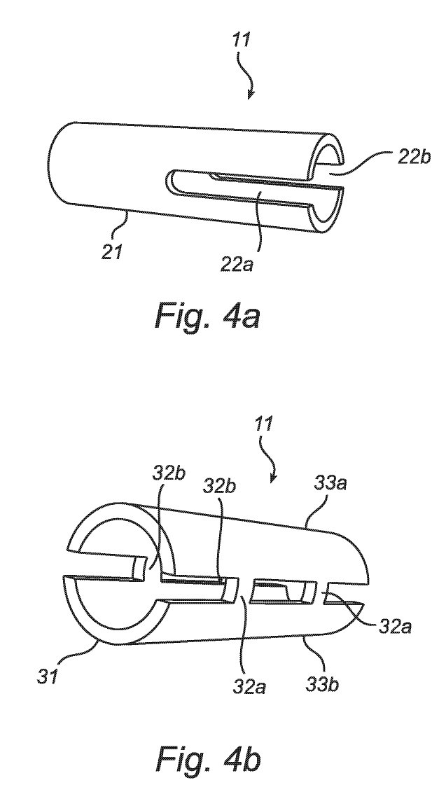

FIG. 4a is a schematic view of a first example of an acoustic detector, according to a second embodiment of the present invention.

FIG. 4b is a schematic view of a second example of an acoustic detector, according to the second embodiment of the present invention.

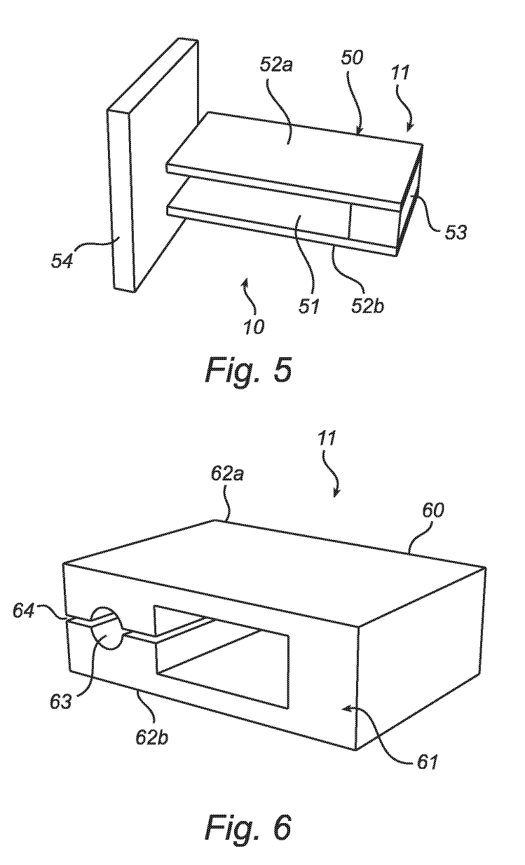

FIG. 5 is a schematic view of an acoustic detector, according to a third embodiment of the present invention.

FIG. 6 is a schematic view of an acoustic detector, according to a fourth embodiment of the present invention.

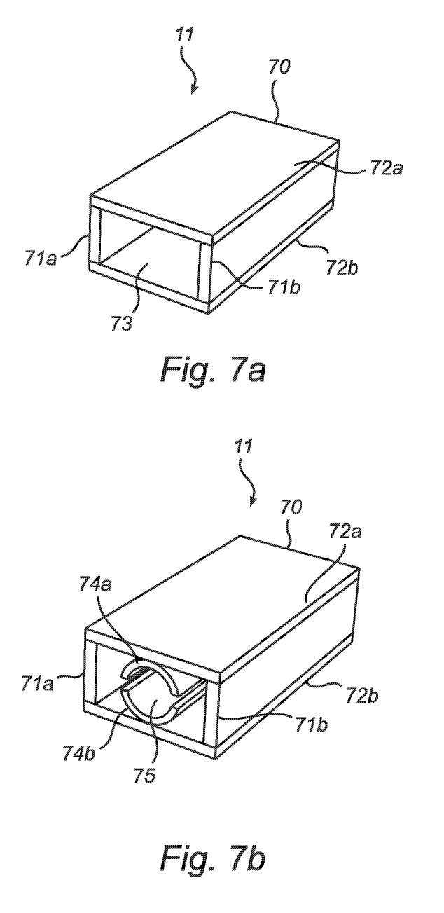

FIG. 7a is a schematic view of a first example of an acoustic detector, according to a fifth embodiment of the present invention.

FIG. 7b is a schematic view of a second example of an acoustic detector, according to a fifth embodiment of the present invention.

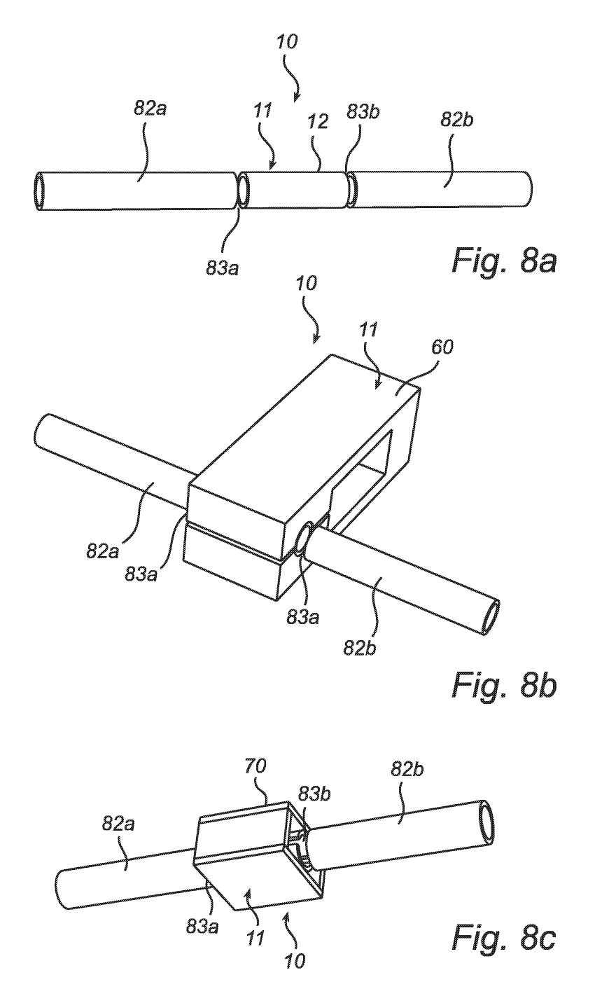

FIG. 8a is a schematic view of a first example of a detector arrangement according to a sixth embodiment of the present invention.

FIG. 8b is a schematic view of a second example of a detector arrangement according to a sixth embodiment of the present invention.

FIG. 8c is a schematic view of a third example of a detector arrangement according to a sixth embodiment of the present invention.

In the following, identical or similar elements are denoted by identical reference numerals.

FIG. 1 shows, by way of reference, a PAS-system 1 according to prior art. Here, a fluid cell 2, containing a sample with a trace gas to be detected, surrounds a quartz tuning fork 3. A laser beam from a laser 4 is focused at a position centered between the prongs 5 of the tuning fork 3 and located at a precise position below the tuning fork opening. The laser 4 is tuned to an absorption frequency of the trace gas contained in the fluid cell 2 and is frequency modulated at half the structural eigenfrequency of the quartz tuning-fork 3, leading to periodic pressure variations due to the absorption of light in the trace gas with a frequency coinciding with the structural eigenfrequency of the quartz tuning-fork 3 (which can be around 30 kHz). These pressure variations are then picked up by the tuning-fork 3 and displayed to an operator by means of suitable equipment.

FIG. 2 schematically shows a PAS-system 1 comprising an acoustic detector 10, having a sensing unit 11 according to a first embodiment of the present invention. The PAS-system 1 shown in FIG. 2 is generally constituted by the same functional elements as the prior art system shown in FIG. 1. One fundamental difference, however, is the configuration of the acoustic detector 10, which is here provided with a sensing unit 11 in the form of a tube 12 manufactured in a piezoelectric material, such as PZT, quartz or similar. The tube 12 has eigenfrequencies, f_{sr,n}, i.e. structural resonance frequencies, which are determined by the material and dimensions of the tube and are characteristic to that particular tube 12. The tube 12 further has an inner radius R and a length L. The dimensions of the cavity inside the tube, i.e. the parameters R and L, together with properties of the fluid present in the tube, determine a series of cavity resonance frequencies, f_{cr,n}, of the cavity resonator formed by the tube 12. In order to take advantage of the amplification obtained near a structural resonance frequency of the tube 12 as well as the amplification of the cavity resonator, the dimensions of the tube 12 (R and/or L) are chosen so that one of the cavity resonance frequencies, f_{cr,n}, of the tube substantially coincides with one of the structural resonance frequencies of the tube 12, f_{sr,n}.

An example of a dimensioning of the tube 11 is schematically shown in FIG. 3a. A commercially available PZT-tube 12 from the company “Piezomechanik Dr. Lutz Pickelmann GmbH (D)” is chosen. The selected tube 12 has the following data, according to the data sheet:

R=5 mm

L=36 mm

fₛᵣ=65 kHz (radially)

From this data follows that, in a setup similar to that of FIG. 1, the wavelength modulation frequency of the laser 4 should be tuned to 65 kHz/2=32.5 kHz. For gases with spectrally broad absorption features and fast relaxation times, an amplitude modulation of the laser at 65 kHz can be applied instead of the wavelength modulation. Next, it will be determined whether the tube 12 can be used as it is or if it has to be modified. The cavity resonance frequency of an open ended tube is given by the following expression:

f_{cr,n}=nv_{sound}/2L_{eff},

where L_{eff} is the effective length due to the end-correction for cavity resonance in an open-ended tube, and is calculated according to the following expression:

L_{eff}=L+1.226R

v_{sound}=344+0.6(T−20° C.) m/s (in air)

With the data of the present example and a temperature in the sample cell 2 of 17° C., L_{eff}=42.13 mm and f_{cr,n}≈4061.2 n Hz.

With n=16, f_{cr}=64,980 Hz, which substantially coincides with the stated eigenfrequency of 65 kHz.

In the above described example, the sensitivity of the acoustic detector, oscillating at its breathing-mode eigenfrequency, is further enhanced by the antinodes present inside the tube and no modifications to the selected tube had to be made. It should be noted that the information on structural resonance frequency (eigenfrequency) from the datasheet does not have the required accuracy and that every type of tube to be used should first be subjected to a frequency sweep at a controlled temperature in order to more precisely determine the structural resonance frequencies of the tube.

Generally, a tube can be excited into several structural resonances. Material properties, orientation and the direction of electric polarization influence these structural resonances.

An advantageous poling configuration is shown in FIG. 3b. A sensing tube 12, fabricated from lead zirconate/lead titanate (PZT) is poled in the radial direction with an inner electrode 33 and an outer electrode 32. These electrodes can be applied in the form of a thin-film of for instance nickel or silver on the inner and outer surfaces of the tube. A breathing-mode structural resonance, where the tube oscillates in the radial direction can be picked up effectively with this electrode configuration. The electrodes 32, 33 are contacted and electric signals are transferred through connection lines 35 to appropriate detection electronics 34. The breathing-mode structural resonance couples strongly to the standing wave pattern inside the cavity resonator formed by the tube 12 when the acoustic-frequency is close to a breathing mode structural resonance frequency (eigenfrequency).

In FIGS. 4a-b, schematic views of examples of an acoustic detector, 11 according to a second embodiment of the present invention are shown.

The detector of FIG. 4a is provided with a sensing unit 11 in the form of a modified tube 21, in which two slits 22a, 22b, extending in the axial direction, have been formed in the tube opposite each other in the radial direction. By modifying the tube in this manner, the efficiency of the cavity resonance is somewhat diminished, but the amplification at the structural resonance frequency may be enhanced so that the total amplification of the detector A_{acoustic}*A_{structural} can be increased. By varying lengths of said slits, the structural resonance frequency can be adjusted with minor influence on the cavity resonance as long as the widths of the slits are small. In addition to a configuration with one or more partial slits, a configuration with one slit along the whole length of the tube might be advantageous for a photoacoustic detector. As well as modifying the dimensions and structure of the tube for tuning the structural resonance, the material composition can be selected to obtain the required structural resonance frequency.

FIG. 4b shows an example of a sensing unit 11 provided in the form of a segmented tube 31 which has been divided along the cylindrical axis and is held together by two or more bridges 32a, 32b. The vibrations from the pressure variations induced by the absorption of laser light in the trace gas to be analysed are thus mainly translated to elongation of the bridges 32a, 32b holding the semi-cylindrical halves 33a, 33b together.

FIG. 5 shows an acoustic detector 10 according to a fourth embodiment, where the acoustic detector is formed by the sensing unit 11, in the form of a tuning fork 50 and a cavity forming element 54 in the form of a plate. The detector 10 has an acoustic cavity 51 with a rectangular cross section. The tuning fork 50 is preferably made out of a combination of materials. Here, the prongs 52a and 52b are made of piezoelectric material and are the active sensing members. The two piezoelectric plates 52a and 52b are fixed on a base 53 to form a planar tuning fork structure 50. This combined structure is fixed close to but still separated from a cavity-forming member 54, here in the form of an additional block, so that a cavity 51 with an appropriate cavity resonance is obtained.

In FIG. 6, an acoustic detector, according to a fourth embodiment of the present invention is shown. The acoustic detector, in this case formed by the sensing unit 11, is shaped in the form of a tuning fork 60 with a base 61 and two prongs 62a and 62b. In this example, the entire tuning fork 60 is made of piezoelectric material. It should, however, be noted that a combination of materials used for the prongs 62a, 62b and the base 61, respectively could be advantageous. According to this embodiment, the prongs 62a and 62b are configured to form an essentially tube-shaped cavity 63 between the prongs 62a, 62b. The spacing 64 between the prongs close to the cavity 63 should be as small as possible. Since the vibration amplitude of the prongs 62a, 62b is in the nm range because of the high stiffness of the piezoelectric material, a spacing in the micron range is preferably applied.

FIG. 7a-b show two examples of an acoustic detector, according to a fifth embodiment of the present invention.

According to the first example, schematically shown in FIG. 7a, the acoustic detector is formed by a sensing unit 11 in the form of an open-ended box 70 with two sides 71a, 71b, made of a piezoelectric material, which are held together by two additional members 72a, 72b, forming the remaining sides of the open-ended box. A cavity 73 with a rectangular cross-section is formed by the open-ended box 70. By selecting proper dimensions of the sides 71a, 71b, 72a, 72b of the open-ended box 70, cavity resonance can be made to co-operate with the structural resonance of the sensing unit 11, thereby amplifying the signals picked up by the acoustic detector.

According to the second example, schematically shown in FIG. 7b, two semi-cylindrically shaped elements 74a, 74b have been attached to the passive sides 72a, 72b of the open-ended box 70. the cavity 75, formed by the sensing unit 70 will thereby become essentially tube-shaped.

The acoustic detector 10 can as illustrated in FIGS. 8a-c, showing examples of a sixth embodiment of the present invention, in addition to a sensing unit 11 comprise a number of supporting, but in themselves non-sensing signal enhancing means 82a, 82b.

In FIG. 8a a first example of the sixth embodiment is shown. Here, the sensing unit 11, in the form of a tube 12 is combined with two tubes 82a, 82b of non-piezoelectrically active material. The dimensions of all the tubes 12, 82a, 82b are configured in such a way that one specific cavity resonance mode exists extending over the three tubes. The spacings 83a, 83b between the tube parts should be as small as possible for optimal confinement of the cavity resonance mode in the cavity resonator formed by the three tubes.

In FIG. 8b, a second example of the sixth embodiment of the invention is shown. Here, the acoustic detector 10 comprises a sensing unit 11 in the form of a tuning-fork 60 (cf. FIG. 6) and cylindrical non-piezelectric signal enhancing means 82a, 82b. The signal enhancing tubes 82a, 82b are positioned as close as possible to the tuning fork 60 so that the spacings 83a, 83b are small and one, substantially continuous, cavity resonator is formed. The cavity formed between the prongs of the tuning fork 60 (cf. FIG. 6) should support the cavity resonance mode. This can be accomplished by choosing the radius of the cylindrical cavity between the prongs to be the same as the radii of the tube-shaped signal enhancing means 82a, 82b.

In FIG. 8c, a third example of the sixth embodiment of the invention is shown. Here, the acoustic detector 10 comprises a sensing unit 11 in the form of an open-ended box 70 enclosing an essentially tube-shaped cavity (cf. FIG. 7b) and cylindrical non-piezelectric signal enhancing means 82a, 82b. The signal enhancing tubes 82a, 82b are positioned as close as possible to the open-ended box 81 so that the spacings 83a, 83b are small and one, substantially continuous, cavity resonator is formed. The cavity formed inside the open-ended box (cf. FIG. 7b) should support the cavity resonance mode. This can be accomplished by choosing the radius of the cylindrical cavity inside the open-ended box to be the same as the radii of the tube-shaped signal enhancing means 82a, 82b.

The person skilled in the art realises that the present invention by no means is limited to the preferred embodiments, for example, one is not limited to an open-ended structure, a closed or semi-closed cavity resonator could also be used as long as the optical beam can pass at least one of the sides and small holes are incorporated for fluid exchange. Furthermore, slits may be formed in any portion of the envelope of the tube, such as parallel to the ends of the tube, and the tube can be divided into segments of any shape. The cross-section of a tube does not necessarily have to be circular, but can be, for example, rectangular or elliptical.

1. An acoustic detector (10), for detecting acoustic signals generated in a photoacoustic spectroscopy system (1) through absorption of light by a fluid, comprising a sensing unit (11), said sensing unit (11) exhibiting structural resonance at or near a frequency of the acoustic signals,
characterized in that the sensing unit (11) forms at least part of a cavity resonator, which is arranged to enable a formation of standing pressure waves inside said cavity resonator at a cavity resonance frequency substantially coinciding with a structural resonance frequency of the sensing unit (11).

2. A detector (10) according to claim 1, wherein the sensing unit (11) comprises a piezo-electric material, such as quartz.

3. A detector (10) according to claim 1, wherein the sensing unit (11) comprises a tube (12; 21; 31), having inner dimensions adapted to enable cavity resonance in a cavity formed by the detector (10) at a frequency substantially coinciding with a structural resonance frequency of said tube (12).

4. A detector (10) according to claim 3, wherein said structural resonance frequency is a breathing mode eigenfrequency for said tube (12).

5. A detector (10) according to claim 3, wherein said tube (21) comprises at least one slit (22a, 22b) in an envelope of the tube (21), said slit (22a, 22b substantially extending in an axial direction.

6. A detector (10) according to claim 3, wherein said tube (31) is divided in the axial direction into at least two segments (33a, 33b), held together by connecting means (32a, 32b) and said connecting means comprise bridges (32a, 32b) formed between the segments (33a, 33b).

7. A detector (10) according to claim 1, wherein the sensing unit (11) is a tuning fork (50; 60) with two prongs (52a, 52b; 62a, 62b) attached to a base (53; 61).

8. A detector (10) according to claim 7, wherein the prongs (62a, 62b) of said tuning fork (60) are configured to form cavity (63) between said prongs (62a, 62b), said cavity (63) having dimensions which are adapted to enable cavity resonance of the detector (10) at a frequency substantially coinciding with a structural resonance frequency of said tuning fork (60).

9. A detector (10) according to claim 7, further comprising a cavity-forming member (54), said member being arranged to enable the formation of a cavity (51), bounded by the cavity-forming member (54) and the prongs (52a, 52b) and base (53) of said tuning fork (50), said cavity (51) having dimensions which are adapted to enable cavity resonance of the detector (10) at a frequency substantially coinciding with a structural resonance frequency of said tuning fork (50).

10. A detector (10) according to claim 1, wherein the sensing unit (11) is formed as an open-ended box (70), having dimensions which are adapted to enable cavity resonance of the detector (10) at a frequency substantially coinciding with a structural resonance frequency of said open-ended box (70).

11. A detector (10) according to claim 10, wherein two sides (71a, 71b) of said open-ended box are made of a piezoelectric material, said sides (71a, 71b) facing each other and being held together by two passive elements (72a, 72b) facing each other.

12. A detector (10) according to claim 11, wherein said passive elements (72a, 72b) of said open-ended box (70) are configured to form an essentially tube-shaped cavity (75) between said them.

13. A detector (10) according to claim 1, further comprising signal enhancing means (82a, 82b), said signal enhancing means (82a, 82b) being arranged to co-operate with said sensing unit (11) to form a cavity resonator having dimensions which are adapted to enable cavity resonance of the detector (10) at a frequency substantially coinciding with a structural resonance frequency of said sensing unit (11).

14. A photoacoustic spectroscopy system (1), comprising a light source (4), an acoustic detector (10) according to claim 1 and an output device (34) configured to display information from the detector (10) to a user.
